(19) United States
(12) Patent Application Publication
(10) Pub. No.: US 2003/0002474 A1
(43) Pub. Date: Jan. 2, 2003

(54) Multi-stream merge network for data width conversion and multiplexing

(76) Inventors: Thomas Alexander, Mulino, OR (US); David Wong, Vancouver (CA)

Correspondence Address: Pascal & Associates, Station D, P.O. Box 3440, Ottawa, ON, K1P 6P1, CA

(21) Appl. No.: 09/812,821

(22) Filed: Mar. 21, 2001

(51) Int. Cl. H04L 12/28; G06F 15/16; H04J 7/00

(52) U.S. Cl. 370/351; 709/247; 370/212; 370/535

(57) ABSTRACT

The present invention relates to a merging network for multiple data streams comprising a pipelined butterfly network. The pipelined butterfly network comprises an input network for receiving a plurality of data streams of mutually constant widths, each data stream having logically related data bits carried on contiguous signal lines, a butterfly network containing suitably interconnected register and multiplexer means for rearranging the received data streams into a time-multiplexed constant-width output data stream, the output data stream having a width equal to or greater than the sum of the widths of the input data streams, and an output network for providing the output data stream interleaved to an output bus.

### FIELD OF THE INVENTION

This invention relates to the field of data transmission, and in particular to a system and method for converting data between various widths or formats.

### BACKGROUND TO THE INVENTION

It is frequently necessary to convert data between various widths or formats. For example, interconnecting buses of different widths (e.g. an 8-bit bus to be interfaced with a 32-bit bus) requires that data be transformed from or to an 8-bit format to or from a 32-bit format. As an example of a more specific requirement, a physical layer device for a telecommunications network interface may need to convert data widths between an optical fiber link on one side of the interface and a local system bus on the other. The data received from the optical fiber may consist of 8-bit bytes, but must be placed on a 32-bit system bus as contiguous 32-bit words.

It is also sometimes necessary to merge different data streams received from separate physical entities into a single stream, or to split one stream among multiple receivers. In this case, the single data stream of high bandwidth would normally be time-division-multiplexed among the several lower-bandwidth streams. For example, 32-bit words carried on a 32-bit bus may have to be split into four streams, with successive 32-bit words being sent to different 8-bit destinations (i.e. the first 32-bit word would be assigned to destination 0, the second to destination 1, etc.). The reverse may also be required, wherein data arriving on four separate 8-bit channels must be accumulated and time-multiplexed to form a single 32-bit channel. This type of processing finds application wherein a single wide data bus must be interfaced to several narrow data buses, or where several physical layer interface devices must be interfaced to a single wide high-speed local system bus.

FIG. 1 illustrates the multiplexing and demultiplexing process. An example of four independent 8-bit data streams A, B, C and D, formed of successive 8-bit words A0, A1, A2 . . . , B0, B1, B2 . . . , C0, C1, C2 . . . and D0, D1, D2 . . . , are input to a merge apparatus 1 which accumulates four bytes at a time from each stream and then outputs parallel 32-bit words to a 32-bit bus 2. Consecutive words 3A, 3B, 3C and 3D carried by the 32-bit bus each consists of four bytes from successive input streams (4 bytes×8 bits/word=32 bit words).

Further, a single 32-bit data stream carrying 32-bit words belonging to logically separate channels is sometimes required to be de-multiplexed into four physically separate 8-bit streams.

It is sometimes required for some applications to be able to merge data from, or split data to, different physical data streams of variable widths, while maintaining a wider constant data bus width. For example, a 128-bit bus may be required to be interfaced with a combination of 8-bit and 32-bit buses, with the aggregate bandwidth of the 128-bit bus being split among the narrower buses in direct proportion to their width. This could be required if several physical layer interface devices are to be connected to the same logical system bus, but the interface devices have different data rates and produce data of different widths.

### DESCRIPTION OF THE PRIOR ART

A number of different ways to solve the above-described data width conversion and merging problems have been employed in widely disparate applications, such as those described in the following U.S. Pat. Nos.: 5,016,011 issued May 14, 1991, invented by R. I. Hartley et al; 4,942,396 issued Jul. 17, 1990, invented by R. I. Hartley et al; 5,802,399 issued Sep. 1, 1998,invented by M. Yumoto et al; 4,747,070 issued May 24, 1988, invented by R. R. Trottier et al; 4,309,754 issued Jan. 5, 1982, invented by J. M. Dinwiddie, Jr.; 4,271,480 issued June 2, 1981, invented by D. Vinot; 4,162,534 issued Jul. 24, 1979, invented by G. H. Barnes; 3,800,289 issued Mar. 26, 1974, invented by K. E. Batcher; 3,686,640 issued Aug. 22, 1972, invented by S. R. Andersen et al; 3,934,132 issued Jan. 20, 1976, invented by D. J. Desmonds; 3,747,070 issued Jul. 17, 1973, invented by J. H. Huttenhoff; and 3,812,467 issued May 21, 1974, invented by K. E. Batcher.

For example, one way in the prior art of solving the merge problem is to use an arrangement of shift registers and multiplexers such that the narrower-width data are shifted into independent, wide, shift registers, one per input data stream, and then the contents of the shift registers are successively multiplexed on to a single wide output bus. The 8-bit to 32-bit conversion example above requires four 32-bit shift registers into which the data streams A, B, C, D are shifted, 8-bits at a time. When a complete 32-bit word becomes available from a particular stream, it is output as a unit on the 32-bit output bus.

This solution suffers from the problem that the complexity of the logic and routing grows as the square of the size of the output bus; an output bus of 256 bits registers and a 32:1 multiplexer that is also 256 bits wide, plus the connection routing area occupied by 32 256-bit data buses. The result is a very large and expensive circuit that is not capable of running at high speeds. In addition, the control complexity becomes substantial when data of different widths must be combined on to the output bus.

Some of the difficulties encountered with the above approach can be solved by utilizing a data random access memory (RAM) to buffer the data. Some degree of reduction in the routing and logic impact may be obtained in this manner. The RAM is required to be operated at a high data rate, high enough to permit data to be written to it from each narrow stream in succession, the narrow streams being multiplexed together on a shared, high-speed data bus. When sufficient data becomes available within the RAM buffer for any one input stream to form a complete word on the wider data bus, the data are read out on to the output bus.

This solution, however, requires the use of a RAM and surrounding logic of extremely high speed, operating at N times the data rate of any one input stream, wherein N is the number of separate streams. This is not feasible or inexpensive when high data rates must be encountered.

Similar structures using individual registers in place of the RAM have also been proposed, but also possess similar problems.

Approaches using shifting networks have been implemented. These are relatively more flexible than the simple shift register mechanism described above, and involve the use of multi-stage shifting networks to shift and align incoming data from narrower streams to various positions in a wider stream, followed by register and buffer logic to merge the various narrow data words together into the desired time-multiplexed output.

However, they suffer from the same problems as noted earlier with respect to the shift register approach, in which the complexity of the logic and routing grows as the square of the size of the output bus, and in addition are not feasible at high speeds and/or large data widths.

### SUMMARY OF THE PRESENT INVENTION

An embodiment of the present invention as will be described herein can provide much less complexity of the implementation logic, layout and routing of interconnections than that required by the earlier shift register implementation described earlier. It is simple and regular, and requires only simple control apparatus.

It can accommodate a number of input data streams, each of which may be a different number of bits in width, and can concatenate consecutive data units from each input stream to produce wider data words which are placed on a wide output data bus.

The number of individual (atomic) data-units in the output data stream is restricted to a power of 2, and the various widths of the input data streams are restricted to power of 2 multiples of each other. The description and claims herein should be construed to contain this limitation if not otherwise stated. For example, a combination of an output data stream of 128 bits in width and various numbers of input data streams that are 8, 16, 32, 64 and 128 bits wide meets this requirement.

The invention can be constructed so that data can flow in either direction of merging/demultiplexing, narrow streams being merged into a wide stream, and wide streams being split into several narrow streams.

The physical assignment of signal lines to channels (i.e. narrow streams) can be arbitrarily modifiable within the power of 2 constraints noted above. For example, considering the example given above, the narrow streams may be distributed in some arbitrary fashion across a set of 128 input signal lines. Thus there may be one 8-bit stream assigned to the first 8 lines, two 32-bit streams assigned to the next 64 lines, three 8-bit streams assigned to the next 32 lines, and one 32 bit stream assigned to the remaining 32 lines.

In accordance with an embodiment of the invention, a merging network for multiple data streams comprises a pipelined butterfly network, wherein the pipelined butterfly network comprises: (a) an input network for receiving a plurality of data streams of mutually constant widths, each data stream having logically related data bits carried on contiguous signal lines, (b) a butterfly network containing suitably interconnected register and multiplexer means for rearranging the received data streams into a time-multiplexed constant-width output data stream, the output data stream having a width equal to or greater than the sum of the widths of the input data streams, and (c) an output network for providing the output data stream interleaved to an output bus.

In accordance with another embodiment, a multi-data-stream merge network comprises: (a) a plurality of shuffle buffers for receiving plural input data streams, (i) each data stream but one having a width which is the same as all other input data streams, and (ii) at least one stream of data having different data width than other ones of the input streams of data and in which the data widths of the streams of data have a power of 2 relationship; the shuffle buffer having a structure for reordering the input streams of data into an interleaved order if not already in interleaved order and providing the interleaved order of data streams at its output, (b) a permutation network for receiving the interleaved order of data streams and rearranging the spatial order of the data streams if desirable or necessary and locating each stream on a specific spatial boundary, and (c) a pipelined butterfly network for receiving the data streams from the permutation network and concatenating data from the received data streams into constant width interleaved words having a width which is wider than any of the input streams of data, and merging the constant width words onto an output bus in a time-division-multiplexed manner.

In accordance with another embodiment, a multi-data-stream merge network comprises a pipelined butterfly network for receiving streams of data which are in interleaved order and which are located at specific spatial boundaries, and includes apparatus for concatenating data from the received streams of data into constant width interleaved words having a width which is wider than any of the received streams of data, and apparatus for merging the constant width words onto an output bus in a time-division multiplexed form so as to produce a constant-width interleaved output data stream.

### BRIEF INTRODUCTION TO THE DRAWINGS

A better understanding of the invention may be obtained by reading the detailed description of the invention below, in conjunction with the following drawings, in which:

FIG. 1 is a block diagram illustrating a multiplexing and demultiplexing process achieved by the present invention,

FIG. 2 is a block diagram illustrating one embodiment of the invention,

FIG. 3 is a block diagram illustrating another embodiment of the invention,

FIG. 4 is a block diagram of a shuffle buffer used in the group of shuffle buffers described in FIGS. 2 and 3,

FIG. 5 is a block diagram of a Benes network of which the permutation network may be comprised,

FIG. 6 is a block diagram of a node used in the Benes network of FIG. 5,

FIG. 7 is a block diagram of a pipelined butterfly network,

FIGS. 8A-8F depict the pipelined butterfly network of FIG. 7 in successive clock cycles, illustrating passage of data therethrough,

FIG. 9 is a block diagram of a pipelined butterfly network having a larger number of inputs than the pipelined butterfly network of FIG. 7, and

FIG. 10 is a block diagram of an embodiment of a system which includes a pipelined butterfly network and input shuffle buffer network for handling data streams of different widths in the same apparatus.

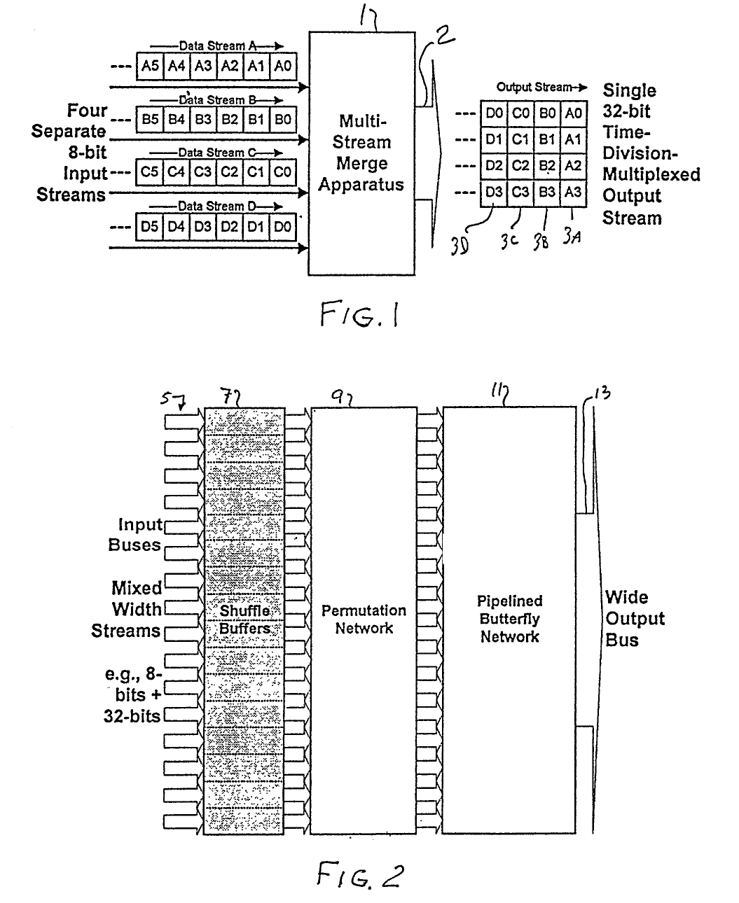

### DETAILED DESCRIPTION OF EMBODIMENTS OF THE INVENTION

Turning to FIG. 2, a plurality of input buses 5 carry mixed width data streams, having the power of 2 relationship described above, i.e. the various widths of the input data streams are restricted to power of 2 multiples of each other.

The mixed width data streams are input to a shuffle buffer network 7 formed of a plurality of shuffle buffers. The shuffle buffer network accepts, buffers and reorders incoming data from the multiple different-data-width input buses, if required, as will be described later.

The output of the shuffle buffer system 7 is applied to a permutation network 9. The permutation network 9 rearranges the different data streams to create interleaved groups based on the input data width, again if necessary as will be described later.

The output of the permutation network 9 is applied to a pipelined butterfly network 11, which outputs its data to a wide output bus 13. The pipelined butterfly network performs the actual merging and data width conversion process on the input data streams to produce a time-division-multiplexed output stream.

It should be noted that these three elements may be used in reverse order, to accomplish the reverse process of accepting a single wide time-multiplexed data stream, splitting it into its constituent parts, and outputting them as multiple narrower streams of different data widths. Due to this operational reciprocity, keeping in mind that the splitting operation is but a reversal of the merging operation, a detailed description of the splitting operation would be redundant to a person skilled in the art. Therefore while a detailed description of the structure of and operation of the system for performing the merging operation will be given, only a brief description, as given later, of the splitting operation is believed necessary for a person skilled in the art.

Concerning operation of the system illustrated in FIG. 2, a number of constant streams of data 5, possibly of several data widths, are presented to the inputs of the shuffle buffers 7, into which the data is written. The data stored in the shuffle buffers is read out in accordance with a specific process to be described later, and is presented to the input of the permutation network 9. The-permutation network 9 rearranges the streams and applies the rearranged streams to the inputs of the pipelined butterfly network 11. The pipelined butterfly network 11 concatenates data from each input stream separately into wider data words (of constant width, regardless of the width of the input stream) and then merges the words for different streams on to the single output bus in a time-division-multiplexed manner.

The output of the pipelined butterfly network 11 is interleaved, i.e. each word output on the bus in any given clock cycle will contain consecutive data units from a single specific data stream; data from different data streams will not be mixed into the same word, and data units are not re-ordered within a given data word with respect to their order of presentation at the input.

The resulting time-division-multiplexed data stream, having the highly desirable properties of constant width, interleaved and predictability (i.e. the order in which words from different streams are presented on the output bus is fixed, regular and is known in advance) can be processed much more simply than the different physically separate data streams of arbitrary width at the inputs. For example, buffering the data for any number of data streams can be accomplished using a single physical memory block that is logically partitioned into separate buffer units utilizing an addressing arrangement which ensures that the sequence of data words are written to the appropriate buffer. Alternatively the output data can be placed on a single wider bus that is connected to some other processing entity, permitting the processing entity from having to be replicated in order to deal with physically distinct data streams.

More particularly, the shuffle buffers which serve to accept data from upstream entities perform three principal functions, one of which is necessary if the shuffle buffers are used, and the other two being additional desirable features but are not absolutely required. These functions are described below, the first function being the necessary function.

1. The input data are accumulated until sufficient data are available in each buffer. At this point, the data are read out in a shuffled order relative to the order in which they were written to the buffer. The shuffling is performed differently depending on the ratio of the width of the input data stream to the width of the output bus 13. The purpose of the shuffling is to properly order the data input to the pipelined butterfly network such that they may appear in interleaved fashion at its outputs. The shuffling is done in a deterministic manner, which is described in more detail later.

2. In the event the data are arriving in an intermittent or bursty fashion (i.e. with long gaps between blocks of data), the shuffle buffers may be configured to accumulate data until complete blocks of data are available within the buffer prior to outputting the data to the permutation network. Once a complete block is available, the shuffle buffer should write out the entire block in sequence (per the shuffling process described in item 1 above) with no breaks. The size of each block should be normally equal to the width of the output data bus from the pipelined butterfly network. The purpose of this is to ensure that the data presented on the output of the stream merging device has no gaps within individual words.

It should be noted that an ancillary function that can be implemented by the shuffle buffer units is to present dummy data to the permutation network when it is empty, or when insufficient data are present to form a complete block. Various other useful functions related to block formation may also be implemented by the shuffle buffers, as will be described later.

The block formation function by the shuffle buffers is optional; the stream merging process will continue to operate in its absence, but in this case the output data may have “holes” in the words.

3. In the event the input data streams are synchronous to different clock signals (as is common when different data streams are being generated by separate physical layer devices), the shuffle buffers may be configured to synchronize the data to a common clock reference. This synchronization process may be done in a well known manner used to transport data between different clock domains.

This synchronization function is an optional function of the shuffle buffer.

The permutation network rearranges the spatial order of the inputs from the upstream data sources before they are presented to the pipelined butterfly network. This is done to permit any arbitrary arrangement of input data streams (i.e. to allow arbitrary assignment of logical streams or components of streams to the physical wires on which data are presented to the shuffle buffers). For example, a particular 32-bit stream may be configured such that its constituent 8-bit byte lanes are scattered over the various input data buses in some random order, possibly intermixed with byte lanes belonging to other streams. The permutation network should in this case be configured to reorder the positions of the streams such that the byte lanes for the 32-bit stream are contiguous and located on a specific boundary. This will be described in more detail later.

The pipelined butterfly network provides the actual merging and width-extension of the various data streams. This network is topologically related to a butterfly graph, and is comprised of three sub-sections: (a) an input delay network, which imposes different fixed delays (in units of clock cycles) on the various input streams, (b) a pipelined butterfly network, which switches and sequences the streams in successive stages to merge and extend the data, and (c) an output delay network, which functions similarly to the input delay network, but serves to align the outgoing data properly, such that interleaved words are placed on the output of the complete apparatus.

It should be noted that the invention does not mandate that all three of the units (shuffle buffers, permutation network and pipelined butterfly network) must be present for all embodiments. One or more of the above (other than the pipelined butterfly network) may be omitted according to the following criteria:

1. In the event the input data streams are all of the same width (e.g. all 8-bit data streams, all 32-bit data streams, etc.) then the shuffle buffer stage may be omitted. This is because no shuffling of data is required if the data are all of identical width. Of course, other auxiliary functions that may be implemented by the shuffle buffers, such as block accumulation and data synchronization may still be required. In this case, a set of simple First In First Out (FIFO) buffers can accomplish such processing.

2. If the input data streams are logically grouped and organized on appropriate boundaries with respect to the signal lines connected to the pipelined butterfly network, then the permutation network may be omitted. For example, if the input data consists of all 8-bit data streams, or all 32-bit data streams, then the streams are inherently organized properly and permutation (or shuffling) is not required. If the input comprises a mixture of, say eight 8-bit streams and two 32-bit streams presented on 128 bit signal lines, but the 32-bit streams are grouped logically and placed on the first 64 lines (i.e. on 32-bit boundaries), and the 8-bit data streams are placed on the next 64 lines, then the shuffle buffers are required to handle the differing data widths but no permutation network is needed to properly organize the streams spatially.

The most basic embodiment of the invention, therefore, comprises the pipelined Butterfly network 11. The shuffle buffers 7 are added if data of different widths must be handled. The permutation network 9 is included if data must be re-organized to bring logically related data streams together on contiguous signal lines.

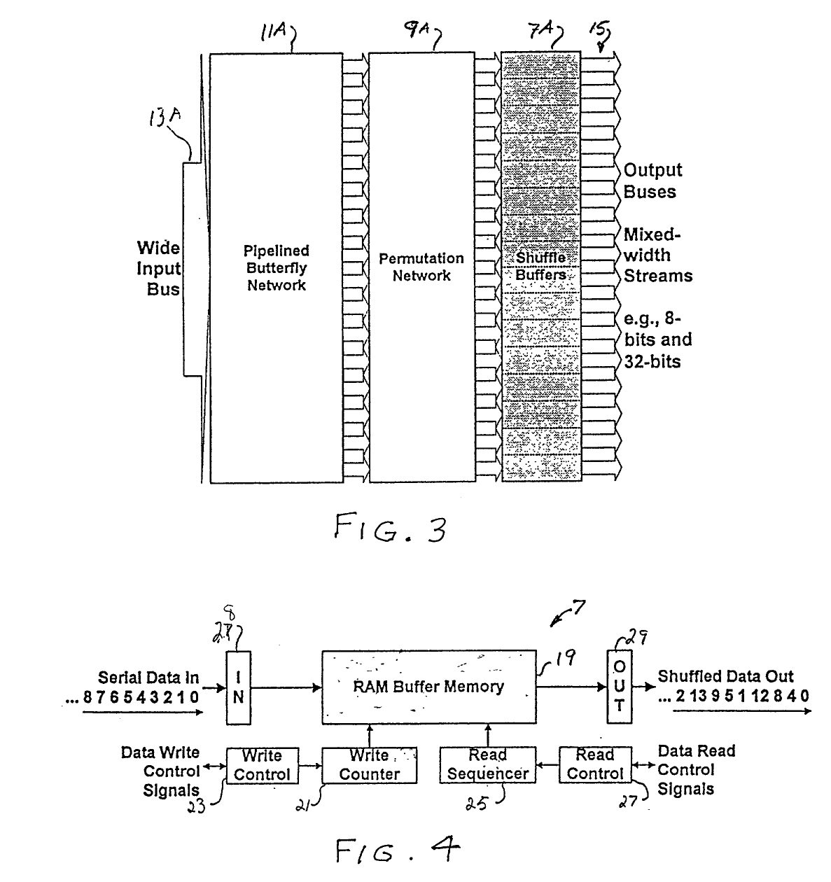

As has been already noted, the apparatus has the desirable property that its constituent parts may be rearranged to perform a data splitting function rather than a data merging function. This is depicted in FIG. 3.

As seen in FIG. 3, a reversal and mirroring of the blocks in the merging system is used to realize a splitting system. The splitting apparatus accepts a time-division-multiplexed stream of constant-width input data words on a wide input bus 13A; the input stream must be regular and repeating in the same format as the output of a similar merging network. The apparatus then follows a reverse procedure to take each input data word, which belongs to a different output stream of some arbitrary (and different) width, and serialize the data word on to the appropriate physical signal wires assigned to that output stream at the output of the apparatus.

The wide input bus 13A inputs the wide data stream to the pipelined butterfly network 11A, which is a mirror image of the network 11 used in the merge system described with respect to FIG. 2. Similarly, the outputs of the pipelined butterfly network 11A are input to the inputs of permutation network 9A. The output signals of the permutation network 9A are input to shuffle buffers 7A, and the outputs of shuffle buffers 7A are applied to mixed width stream output buses 15.

Since the basic operation and construction of the splitting network of FIG. 3 are identical to the merge apparatus of FIG. 2 but with mirror symmetry, no further description of the splitting apparatus will be made as its structure and operation will be understood by a person skilled in the art who has read and understood the reverse direction embodiment.

The structure and operation of each block will now be described in detail.

Note that W represents below the lowest common divisor of the width of each of the (narrow) data streams that are merged to form the wide time-division--multiplexed output, and N represents the ratio of the width of the output stream to W. As a specific example, if 8-bit, 32-bit and 64-bit streams are being merged by the invention to create a single 128-bit time-division-multiplexed output stream, then W is 8 (the minimum stream size is 8 bits, and this is also the common factor among all the input streams) and N is 16 (there are 16 such 8-bit streams that can be multiplexed into a 128-bit output). Various other parameters will be defined as required. The fundamental data unit in this case is an 8-bit byte.

### Shuttle Buffer

With reference to FIG. 4, each shuffle buffer 7 is comprised of three primary sub-sections: a RAM buffer memory 19, write logic containing a write address generation counter 21 and some control logic 23, and read logic containing a read address sequencer 25 and some control logic 27. Input interface 28 receives serial data at its input and outputs the serial data to inputs of the RAM buffer memory 19. Output interface 29 receives shuffled data from the memory 19 and provides it to an output bus.

The RAM buffer memory 19 stores input data at memory locations controlled by the write logic, and holds and accumulates the data input to it from input 28 until it can be read out in shuffled order as controlled by the read logic. The buffer memory 19 is B by W bits in size, where B is the number of data units (words) that can be held and W is the width of each data unit as supplied to the permutation network 9. Typically, B is expected to be some multiple of the number of data units N that comprise a single data word applied on the output bus of the pipelined butterfly network; thus if the butterfly network output is 128 bits wide and the input data units are in terms of 8-bit bytes, the buffer memory will be some multiple of sixteen 8-bit bytes in size. The shuffling process requires this multiple to be a minimum of 1, as shuffling cannot begin until an entire output word's worth of data are present in the buffer; normal values for the multiple range between 2 and 3 (implying a 32×8 or 48×8 RAM). The purpose of having more than N units of storage in the RAM is to permit fresh data to be written into the buffer while previously stored data are being read out in a shuffled fashion.

The write logic generates the address sequence required for writing data into the RAM buffer, and also implements the control functions needed to prevent data from being written into the buffer when no free space exists (i.e., normal FIFO write control functions). The address sequence is very simple, being an incrementing series of addresses starting at 0 and wrapping around after the end of the RAM buffer has been reached. The write logic is virtually identical to standard write addressing and control logic used in common FIFO queue structures.

The read logic generates the special sequence of addresses that causes the data to be read out of the buffer memory in shuffled fashion. This logic is also very similar to that of standard FIFO queue read control units, but with two exceptions. Firstly, the series of read addresses generated for successive words read out of the FIFO is not sequential, but instead forms an interleaved pattern. Secondly, the read logic does not permit reading to begin until there is sufficient data to form a complete sequence (i.e., enough to form a complete data word at the output of the butterfly network).

The table 1 below gives some examples of the time sequence in which data must be read out for various ratios between the output and input data word sizes for various streams. It is assumed that the width of the output data word is always 16 bytes (i.e., the data unit being a byte of 8 bits). Successive rows of table 1 give the successive addresses generated by the read logic.

TABLE 1

| # byte lanes per | | | | | |
|---|---|---|---|---|---|
| Input Word | 1 | 2 | 4 | 8 | 16 |
| (Intrinsic Input | (8- | (16- | (32- | (64- | (128- |
| Word Width) | bits) | bits) | bits) | bits) | bits) |
| Read Addr #0 | 0 | 0 | 0 | 0 | 0 |
| Read Addr #1 | 1 | 8 | 4 | 2 | 1 |
| Read Addr #2 | 2 | 1 | 8 | 4 | 2 |
| Read Addr #3 | 3 | 9 | 12 | 6 | 3 |
| Read Addr #4 | 4 | 2 | 1 | 8 | 4 |
| Read Addr #5 | 5 | 10 | 5 | 10 | 5 |
| Read Addr #6 | 6 | 3 | 9 | 12 | 6 |
| Read Addr #7 | 7 | 11 | 13 | 14 | 7 |
| Read Addr #8 | 8 | 4 | 2 | 1 | 8 |
| Read Addr #9 | 9 | 12 | 6 | 3 | 9 |
| Read Addr #10 | 10 | 5 | 10 | 5 | 10 |
| Read Addr #11 | 11 | 13 | 14 | 7 | 11 |
| Read Addr #12 | 12 | 6 | 3 | 9 | 12 |
| Read Addr #13 | 13 | 14 | 7 | 11 | 13 |
| Read Addr #14 | 14 | 7 | 11 | 13 | 14 |
| Read Addr #15 | 15 | 15 | 15 | 15 | 15 |

The general process for obtaining the sequence of addresses to use in order to properly shuffle the data read out of the buffer may be described as follows.

Let N represent the number of atomic data units in each output word (at the output of the butterfly network), and let k represent the number of atomic data units in each input word for a given stream. The quantity d should be computed as being the ratio of N divided by k. This quantity is referred to as the step distance. Now the method below should be followed:

1. Start the read address sequence at zero (i.e., let the first read address be 0) and read out the first data word.

2. Increment the read address by the step distance d.

3. If the incremented read address is greater than N then subtract N from the result and add 1 to it.

4. Read the next data unit at the current read address.

5. Repeat steps 2, 3 and 4 until the read address becomes 15 (or, equivalently, sixteen words have been read out of the buffer) then stop.

Note that the address sequence described above assumes that the buffer size B is only N data units. If B is some multiple of N, the same method is used to derive the sequence, but the first read address generated by step 1 of the method is offset by an incrementing multiple of N prior to using it to access the buffer. The effect is to divide the buffer into blocks of N units, and to read the data within a given block according to the computed sequence, after which the next block is read, and so on.

As previously mentioned, two optional features may be included as part of the functions to be implemented by the shuffle buffer: synchronization and data accumulation.

With respect to synchronization, it should be noted that the shuffle buffer structure resembles a standard synchronizing FIFO queue (with the exception of the read logic, which generates a variable sequence of addresses rather than a simple incrementing sequence as in a standard synchronizing FIFO). Therefore, a standard means of clock synchronization and transport of data values across clock boundaries may be employed to allow the read and write ports of the shuffle buffer to use different clock references.

Data accumulation is required when either the input (write) data rate is lower than the output (read) data rate, or when gaps exist in the write data stream. Well known means of handling gaps in the data stream, as usually implemented in a regular FIFO queue, are employed on the write side of the shuffle buffer. On the read side, however, there may be periods when the buffer is either completely empty or does not contain enough data to permit the reading process to start (i.e., there are less than N data units in it). The shuffle buffer in this case may be constructed so as to send exactly N “dummy” (invalid) data values to the permutation network whenever this situation is encountered, and to continue to send groups of N dummy values until the FIFO contains N or more data items. This ensures that the data stream between the shuffle buffer and the permutation network is delimited in units of N, and avoids “holes” within the output data words produced by the pipelined butterfly network.

As many shuffle buffers, each of width equal to one data unit W, are required as there are data units in the input streams. A total of N buffers is therefore needed (according to the notation already described). All of these buffers can operate independently with regard to the input (writing) of data, but must be synchronized to each other with respect to reading, i.e., the same clock is supplied to all buffers for reading, and data unit #0 is read out of all buffers within the same clock cycle. This ensures that the data presented to the permutation network will be aligned with regard to the different data streams, a necessary condition for merging data so as to obtain properly ordered words at the output of the pipelined butterfly network. If this condition is not satisfied (i.e., the read-out of data from different buffers is not aligned) then the pipelined Butterfly network will maintain interleaving with regard to the separate streams (i.e., it will not merge data units from different streams into the same output word) but there may be “holes” in the output words, and data may be misaligned within individual output words.

### Permutation Network

The function of the permutation network is to allow any arbitrary (but non-conflicting) assignment of input signal lines to data streams, or to byte lanes within a given data stream. Given such an arbitrary assignment, the permutation network can be configured to re-order the spatial distribution of the data streams to allow the pipelined Butterfly network to function properly. The permutation network may be formed from any rearrangeable multistage network, i.e., a network where any arbitrary one-to-one mapping between the set of inputs and the set of outputs may be implemented without blocking between paths, and a subset of the paths may be altered without disturbing the remainder. One of the simplest rearrangeable networks is the Benes network, which is well known in the literature.

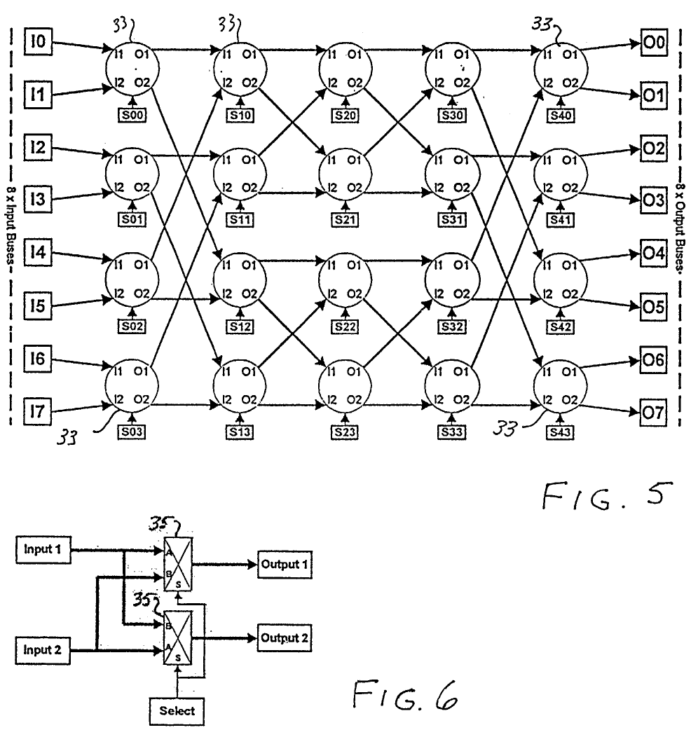

As an example, a Benes network capable of connecting 8 input buses to 8 output buses in any one-to-one order is depicted in FIG. 5.

As shown in FIG. 5, the Benes network is comprised of a set of elements (or nodes 33, indicated by the circles) interconnected by wires (or arcs). The width of each arc of the network is equal to the number of bits W in the basic data units presented on the input data streams to the apparatus (typically, 8 bits). Each of the nodes of the network can be separately configured to act as a “pass-through” or a “crossover”.

A node is formed from a pair of multiplexer units as shown in FIG. 6. Each of a pair of signal inputs Input 1 and Input 2 is connected to inputs A and B of the multiplexers 35 and 37; Inputs 1 and 2 are respectively connected to corresponding inputs A of the multiplexers and to corresponding inputs B of the other multiplexers. A select control input signal is applied to the S (select) inputs of both multiplexers.

When the select control input signal is set to a logical 0, Input 1 is connected to Output 1 of one multiplexer and Input 2 is connected to Output 2 of the other multiplexer (i.e. the node is configured to pass data straight through). When Select is a 1, then Input 1 is connected to Output 2 and Input 2 is connected to Output 1 (i.e. the node is set up in a crossed configuration).

With this multiplexer arrangement, any one-to-one mapping can be set up between the inputs and outputs. An example of an arbitrarily chosen mapping for the 8×8 Benes network being considered herein as an example, and the corresponding Select control input signals required to be presented to the nodes, is shown in the table 2, 3 and 4 below.

TABLE 2
Mapping
In->Out
I0->O6
I1->O5
I2->O4
I3->O3
I4->O2
I5->O1
I6->O0
I7->O7

TABLE 3

| S | S | S | S | S | S | S | S | S | S |
|---|---|---|---|---|---|---|---|---|---|
| 00 | 01 | 02 | 03 | 10 | 11 | 12 | 13 | 20 | 21 |
| 0 | 0 | 0 | 0 | 0 | 1 | 0 | 0 | 1 | 1 |

TABLE 4

| S | S | S | S | S | S | S | S | S | S |
|---|---|---|---|---|---|---|---|---|---|
| 22 | 23 | 30 | 31 | 32 | 33 | 40 | 41 | 42 | 43 |
| 0 | 0 | 0 | 1 | 1 | 0 | 0 | 0 | 0 | 0 |

Any other desired mapping will have some other unique combination of Select signals S that establishes a set of paths from the inputs to the outputs to satisfy that mapping. It is preferred that these Select signals should be statically configured prior to operation of the apparatus in accordance with the distribution of input data streams on the actual input signal lines, so as to re-order the data streams in a regular fashion (i.e., byte lanes belonging to the same data stream should be adjacent to each other, in ascending order, and aligned to natural boundaries).

As an example of such a rearrangement, consider the case of four 8-bit streams A₀, A₁, A₂ and A₃; two 32-bit streams {B₀₃, B₀₂, B₀₁, B₀₀} and {B₁₃, B₁₂, B₁₁, B₁₀} (where “{x, y, z, w}” represents the concatenation of byte lanes x, y, z and w); and one 64-bit stream denoted as {C₀₇, C₀₆, C₀₅, C₀₄, C₀₃, C₀₂, C₀₁, C₀₀}. If these streams are input in a “jumbled” order from left to right as follows:

{C₀₆, A₀, B₀₀, B₀₁, B₀₂, B₀₃, B₁₃, A₁, B₁₂, C₀₇, C₀₅, C₀₄, C₀₃, C₀₂, C₀₁, C₀₀, B₁₁, A₂, B₁₀, A₃},

then a 16×16 Benes network with 8-bit wide arcs may be used to re-order the streams into the regular form:

{C₀₇, C₀₆, C₀₅, C₀₄, C₀₃, C₀₂, C₀₁, C₀₀, B₀₃, B₀₂, B₀₁, B₀₀, B₁₃, B₁₂, B₁₁, B₁₀, A₃, A₂, A₁, A₀}

which is required by the pipelined butterfly network to operate properly.

As can be seen from the example, the byte lanes for individual streams must be grouped together in descending order, and the streams must be aligned on proper boundaries (64-bit streams on 64-bit boundaries, 32-bit streams on 32-bit boundaries, and 8-bit streams on any boundary).

Benes networks can be constructed for an arbitrarily large total number of input data units N in the input data streams. For a system having N input data units, where N must be a power of 2, the Benes network requires (2×log₂N−1) columns of multiplexer nodes.

It will be understood by a person skilled in the art that register elements may be interposed between stages of the permutation network in order to pipeline the network and permit it to operate at high speeds. Further, the permutation network may be placed upstream of the shuffle buffers rather than downstream, so that the data is re-arranged in the spatial domain before being re-ordered or shuffled in the time domain, rather than after.

As noted earlier, the permutation network may be omitted if the input data streams are already properly arranged.

### Pipelined Butterfly Network

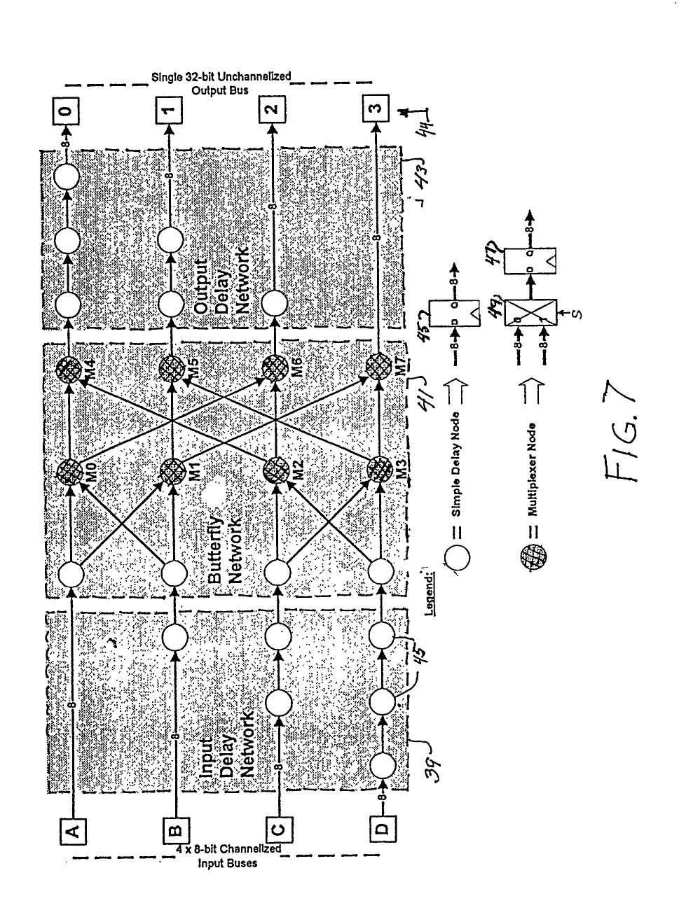

As mentioned earlier, the pipelined butterfly network performs the actual data width extension and merging functions. As shown in FIG. 7, it is comprised of an input delay network 39, which feeds a butterfly network 41, which feeds an output delay network 43. As in the case of the Benes network, the pipelined butterfly network increases in size according to the total number of data units N in the input data streams. An example of a 4×4 pipelined butterfly network for handling 8-bit data will be described below, and is shown in FIG. 7.

The pipelined butterfly network shown can extend and merge four data streams A, B, C and D, each of 8-bits in width, into a time-division-multiplexed sequence of 32-bit words 1, 0, 2, 3 at the output bus.

The uncrosshatched circles 45 represent simple registers (delay stages), and the cross-hatched circles M0-M7 represent registers 47 with 2:1 multiplexers 49 at their inputs. All of the registers are clocked at the same time (i.e. the entire network is synchronous). Each multiplexer has a single select control input S that is used to select one of the two inputs which connect to the outputs of a pair of registers in adjacent input delay network output paths, as shown. The select inputs S are modified on every clock cycle in a regular and repeating pattern, as will be described later.

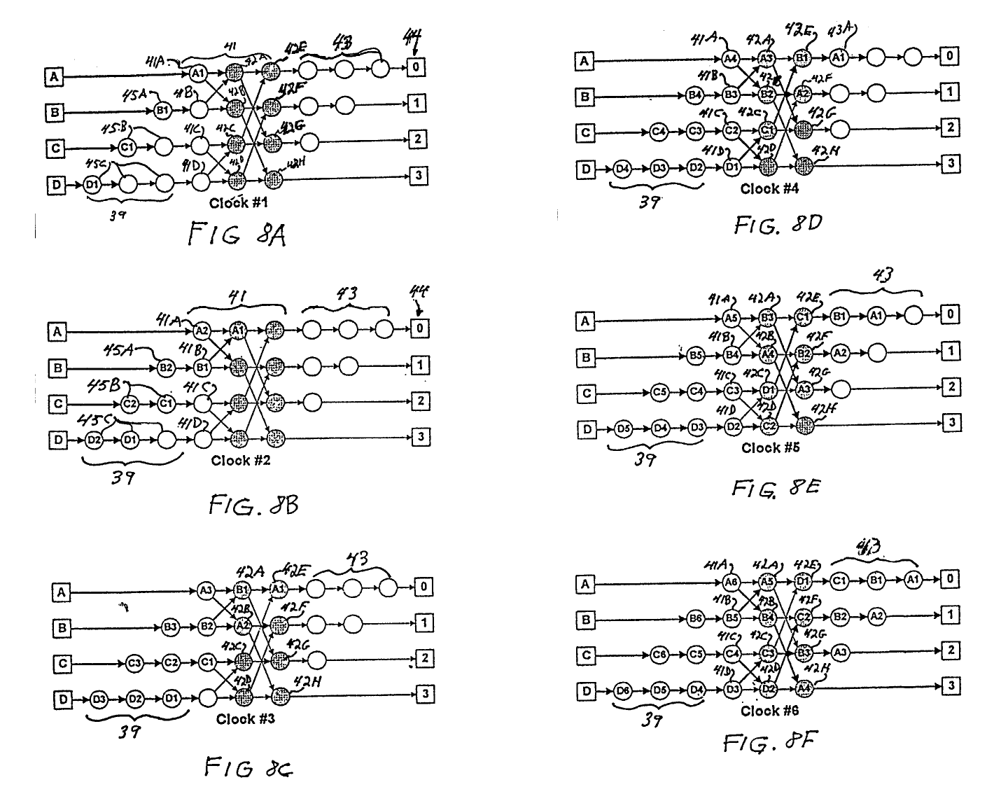

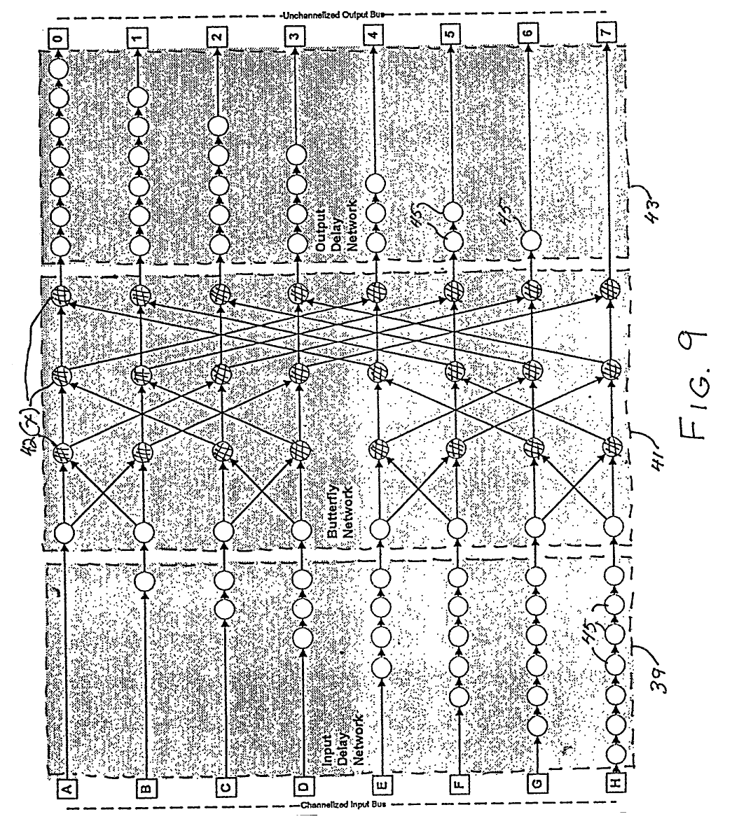

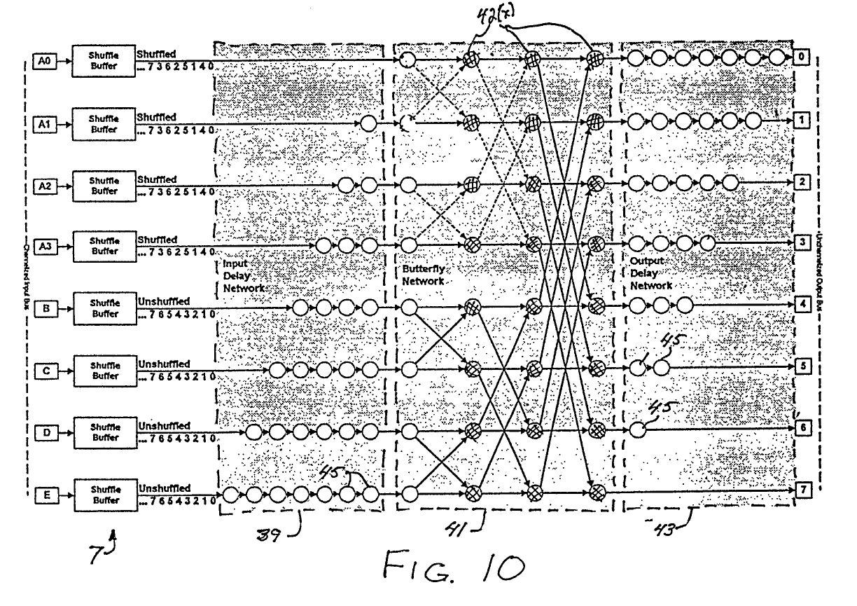

FIGS. 8A-8F illustrate the state of the network in 6 successive clock cycles, whereby four 8-bit streams of data at the inputs may be organized by the shown 4×4 network into interleaved 32-bit data words at the outputs.

It is assumed that all of the input streams present their first byte, their second byte, their third byte, etc. in unison on successive clock cycles. After six clock cycles, the first 32-bit word of data (containing four consecutive bytes drawn from the first input stream) will appear at the output bus. From then on, successive 32-bit words of data belonging to consecutive streams will be placed on the output bus on every clock.

In FIGS. 8A-8F, the input data streams are represented by {A1, A2, A3, A4, A5, A6 . . . }, {B1, B2, B3, B4, B5, B6 . . . }, {C1, C2, C3, C4, C5, C6 . . . }, and {D1, D2, D3, D4, D5, D6 . . . }; the output data words follow the sequence {A1, A2, A3, A4}, {B1, B2, B3, B4}, {C1, C2, C3, C4}, {D1, D2, D3, D4}, {A5, A6, A7, A8}, {B5, B6, B7, B8}, etc.

Turning to FIG. 8A, it may be seen that the input data stream A(x) is received at input A, data stream B(x) is received at input B, data stream C(x) is received at input C and data stream D(x) is received at input D. Data stream A(x) is passed directly without delay to an input register 41A of the butterfly network 41; data stream B(x) is passed to the input register 41B of the butterfly network through one delay unit (e.g. clock period) 45A; data stream C(x) is passed to the input register 41C of the butterfly network through two delay units 45B; data stream D(x) is passed to the input register 41D of the butterfly network through three delay units 45C.

To generalize, each respective successive parallel input data stream passes through a delay network which contains P serial delay stages, where P=(M−1), M being a whole number counting from 1 representing a count of each respective successive input data stream, for receiving the streams of data and passing each stream to an input of a corresponding multiplexer of a first stage of the multiplexers. It may be seen that the first data stream does not encounter any delay in the input delay network.

It should be noted that while the input register of the butterfly network is considered to be part of the butterfly register, it could as easily be considered as the last delay element of the delay network for each data stream. In that case the “−1” would disappear from the above equation. In this specification, the equations should be considered to be the same, depending on whether the input register is or is not considered to be part of the delay network.

The first byte of each of the data streams is stored, with the first clock pulse (clock #1), in the first delay (e.g. register) it encounters, as is shown in FIG.

The outputs of each pair of the input registers of the butterfly network 41 are connected to each of the two inputs of a pair of multiplexers. Thus the output of register 41A is connected to the 0 inputs of multiplexers 42A and 42B; the output of register 41B is connected to the 1 inputs of multiplexers 42A and 42B. Similarly the output of input register 41C is connected to 0 inputs of multiplexers 42C and 42D, and the outputs of register 41D are connected to the 1 inputs of registers 42C and 42D.

The outputs of multiplexers 42A and 42B are connected respectively to the 0 inputs of multiplexers 42E and 42F, and are connected respectively to the 0 inputs of multiplexers 42G and 42H. The outputs of multiplexers 42C and 42D are connected respectively to the 1 inputs of multiplexers 42G and 42H, and are also connected respectively to the 1 inputs of multiplexers 42E and 42F.

The general form of the array of multiplexers described is referred to herein as a butterfly network.

On the second clock pulse (clock #2), the data is shifted to the right, as is shown in FIG. 8B. Thus the first byte A1 of data stream A(x) is shifted into the first multiplexer, and the second byte A2 is stored by the first register 41A. The first byte B1 of data stream B(x) is shifted from the delay (register) 45A into the input register 41B of the butterfly network, and the second byte B2 is stored in the delay (register) 45A. Similarly the successive bytes of the data streams C(x) and D(x) are shifted to successive delay (registers) as shown.

On the next clock pulse (clock #3), as shown in FIG. 8C the byte A1 passes from multiplexer 42A to multiplexer 42E (see the select signal table below), and the byte B1 passes from the input register 41B to multiplexer 42A. Byte A2 passes from input register 41A to multiplexer 42B. The delays incurred by data streams C(x) and D(x) cause those data streams not yet to enter the multiplexer array.

The heavy lines in these figures represent the paths taken by valid data words within a given clock cycle; implicitly they represent the multiplexer select signals that must be used.

In FIG. 8D, at the next clock pulse (clock #4), the first byte A1 of data stream A(x) has passed from multiplexer 42E to a first delay (register) 43A of the output delay network, while the second byte A2 is still in the final multiplex stage, in multiplexer 42F. The first byte B1 of data stream B(x) follows byte A1 by one clock pulse, on the same line.

As shown in FIG. 8E, at the next clock pulse (clock #5) byte A1 is in the second delay (register) of the output delay network 43, and byte B1 is in the first. Byte Cl is in the last multiplexer stage, in multiplexer 42E, to follow the same delay path and bytes A1 and B1. Byte A2 is in the first delay (register) of the line that is adjacent to the one carrying byte A1. Bytes A3 and B2 are in the last multiplexer stage.

In FIG. 8F, at the next clock pulse (clock #6), all of the bytes of each word of serial data stream A(x) have been transposed to a separate line, and appear in parallel at the same time on output bus 44. An examination of FIG. 8F will also show that the bytes of serial data stream B(x) will follow by one clock pulse the parallel byte of data stream A(x). The parallel bytes of serial data stream C(x) and D(x) follow in succession, after which the process repeats for byte streams A(x), B(x), C(x) and D(x).

The serial data streams appearing on separate lines have thus been transposed into interleaved parallel time-division-multiplexed bytes and placed on an output bus.

With reference again to FIG. 7, if a multiplexer select of ‘0’ causes it to select the horizontal input, and a select of ‘1’ causes the diagonal or cross input to be selected, then the following table 5 gives the multiplexer select signals required for the multiplexer nodes M0-M7. Note that multiplexer nodes M0-M7 shown in FIG. 7 and referred to in the following table correspond to multiplexers 42A-42H respectively.

TABLE 5

| Clock | | | | | | | | |
|---|---|---|---|---|---|---|---|---|
| Cycle | M0 | M1 | M2 | M3 | M4 | M5 | M6 | M7 |
| Clock #1 | 0 | — | — | — | — | — | — | — |
| Clock #2 | 1 | 1 | — | — | 0 | — | — | — |
| Clock #3 | 0 | 0 | 0 | — | 0 | 0 | — | — |
| Clock #4 | 1 | 1 | 1 | 1 | 1 | 0 | 1 | — |
| Clock #5 | 0 | 0 | 0 | 0 | 1 | 1 | 1 | 1 |
| Clock #6 | 1 | 1 | 1 | 1 | 0 | 1 | 0 | 1 |
| Clock #7 | 0 | 0 | 0 | 0 | 0 | 0 | 0 | 0 |
| Clock #8 | 1 | 1 | 1 | 1 | 1 | 0 | 1 | 0 |
| . | . | . | . | . | . | . | . | . |
| . | . | . | . | . | . | . | . | . |
| . | . | . | . | . | . | . | . | . |

Following the table 5 above for control of the multiplexers, and the heavy lines on FIGS. 8A-8F, it may be seen that the serial words in each input data stream are transposed to parallel bytes in an output data stream. As can be seen from the table, the multiplexer select signals are a simple and regular repeating pattern. The select signals for M0-M3 (i.e. the first column of multiplexers) all toggle between 1 and 0 on every clock. The select signals (selects) for M4-M7 toggle between 1 and 0 on every other clock. In general, for the i^{th} stage of a pipelined butterfly network, (i=0 for the first stage) the multiplexer selects will toggle after 2ⁱ clock cycles. In addition, the starting value for the sequence of toggles is offset by k modulo 2⁽ⁱ⁻1) for the k^{th} successive multiplexer in the i^{th} stage of multiplexers, as can be seen from the table. The resulting control logic is thus exceedingly simple to implement, comprising a set of 2⁽ⁱ⁻1) toggle flip-flops for the i^{th} stage of multiplexers, with the toggle flip-flops being loaded with a constant pattern on reset and then always toggling on the appropriate clock cycle thereafter.

A pipelined butterfly network may be built for any arbitrary number of input streams comprising N data units in total, where N must be a power of 2. To build such a network, there must be a total of (N×(N−1)/2) register units in the input delay network, N×log₂N multiplexer units, N×(log₂N+1) register units in the actual butterfly network, and (N×(N−1)/2) additional register units in the output delay network. The total latency, in clock cycles, from the input of the first data unit on the first (topmost) stream to its emergence at the output is (log₂N+N).

An example of an 8×8 pipelined butterfly network, capable of handling 8 streams of input data A-H and generating an 8-wide time-multiplexed sequence of output data 0-7, is shown in FIG. 9. The reference numerals and letters used are similar to those of FIGS. 8A-8F. Operation is similar to that of FIGS. 8A-8F, and the person skilled in the art should make reference to that description for an understanding of operation of the embodiment of FIG. 9.

The pipelined butterfly network has been described so far as handling data streams that are all of the same width, the width being equal to the smallest data unit (typically, this is 8-bits, although any arbitrary number of bits may be used without loss of generality). It is sometimes necessary to deal with data streams of different widths in the same apparatus (as, for example, when merging data streams from different physical layer devices having different speeds). It is possible to accomplish this with the use of the shuffle buffers previously described, along with special control of the multiplexer stages in the pipelined butterfly network. The present invention can, as a result, deal with data streams whose widths are related to each other in powers of 2, and are also less than or equal to the width of the output data bus, and wherein ths sum of the input data stream widths does not exceed the width of the output data bus.

Two configuration parameters must be changed in order to deal with a data stream of width k units, where k is a power of 2. Firstly, the read ports of the shuffle buffers for all the byte lanes of the given data stream must all be configured to shuffle the data being read out, according to the method described earlier.

Secondly, the first log₂k stages of multiplexers of the pipelined butterfly network must not be allowed to toggle, but must be frozen with their select inputs configured in straight-through mode. This is depicted pictorially in FIG. 10, which considers 5 input streams (4 of which are 8-bits wide and 1 of which is 32-bits wide), that must be merged on to a 64-bit output bus using 8 shuffle buffers and an 8×8 pipelined butterfly network.

The permutation network is omitted in this drawing for simplicity, the data streams being assumed to be grouped and aligned on natural boundaries. The components of the 32-bit data stream are denoted as {A0, A1, A2, A3}, and the four 8-bit streams are B, C, D and E.

As may be seen from FIG. 10, the first four byte lanes A0, A1, A2 and A3 belong to one 32-bit stream and are hence shuffled, while the next four byte lanes B, C, D and E are assigned to four independent 8-bit streams and are output unshuffled from the shuffle buffers. The pipelined butterfly network is also differently configured from the previous embodiment; as denoted by the dashed lines, the first two stages (k=4 units for the 32-bit stream, and log₂k=2)of multiplexers for the first four byte lanes are frozen in a straight-through configuration, and all the rest of the multiplexers operate otherwise normally as described earlier.

The resulting apparatus produces a sequence of on the eight output byte lanes as shown in the wing table 6 (note that the clock cycles neglect the taken to accumulate 8 bytes into the shuffle buffers).

TABLE 6

| Clock | Lane | Lane | Lane | Lane | Lane | Lane | Lane | Lane |
|---|---|---|---|---|---|---|---|---|
| Cycle | #0 | #1 | #2 | #3 | #4 | #5 | #6 | #7 |
| 0 | — | — | — | — | — | — | — | — |
| . | . | . | . | . | . | . | . | . |
| . | . | . | . | . | . | . | . | . |
| . | . | . | . | . | . | . | . | . |
| 12 | A00 | A10 | A20 | A30 | A01 | A11 | A21 | A31 |
| 13 | A02 | A12 | A22 | A32 | A03 | A13 | A23 | A33 |
| 14 | A04 | A14 | A24 | A34 | A05 | A15 | A25 | A35 |
| 15 | A06 | A16 | A26 | A36 | A07 | A17 | A27 | A37 |
| 16 | B0 | E1 | B2 | B3 | B4 | B5 | B6 | B7 |
| 17 | C0 | C1 | C2 | C3 | C4 | C5 | C6 | C7 |
| 18 | D0 | D1 | D2 | D3 | D4 | D5 | D6 | D7 |
| 19 | E0 | E1 | E2 | E3 | E4 | E5 | E6 | E7 |
| . | . | . | . | . | . | . | . | . |
| . | . | . | . | . | . | . | . | . |
| . | . | . | . | . | . | . | . | . |

In the above table 6, A_{zy} denotes the y^{th} byte input on byte lane x of the 32-bit data stream; B_{y}, C_{y}, D_{y} and E_{y} indicate the y^{th} bytes of the 8-bit data steams, respectively. As can be seen, the output is extended to 64 bits, interleaved, aligned and time-multiplexed in the order of the byte lanes. Clearly the objectives of the invention have been achieved.

A person understanding the above-described invention may now conceive of alternative designs, using the principles described herein. All such designs which fall within the scope of the claims appended hereto are considered to be part of the present invention.

We claim:

1. A multi-data-stream merge network comprising a pipelined butterfly network for receiving parallel streams of data which are in interleaved order and which are located at specific spatial boundaries, and which includes means for concatenating data from the received streams of data into constant width interleaved words having width which is wider than any of the received streams of data, and means for merging the constant width words onto an output bus in a time-division multiplexed form so as to produce a constant-width interleaved output data stream, wherein the pipelined butterfly network is comprised of j*log₂j successive stages of multiplexers and j*(log₂j+1) delay stages, in which j represents the number of parallel lines of byte lanes of input streams of data, the multiplexers being interconnected in a butterfly pattern, apparatus for applying select signals to the multiplexers which select signals toggle after 2ⁱ clock signals for the i^{th} stage of multiplexers following a starting value for a sequence of select signals offset by k modulo2⁽ⁱ⁻1) for each successive multiplexer in the i^{th} stage of multiplexers.

2. A network as defined in claim 1, further comprising an input delay network containing P serial delay stages in which each respective successive parallel input data stream is delayed by said P serial delay stages, where P=(M−1), M being a whole number counting from 1 representing a count of each respective successive input data stream, said input delay network receiving the streams of data and passing each stream to an input of a corresponding multiplexer of a first stage of said multiplexers.

3. A network as defined in claim 1, further comprising an output network for providing an output data stream from a last stage of said multiplexers, the output network being comprised of an output delay network comprising a number of delay stages Q in each parallel stream carrying the output data stream wherein Q=(R−X), where R represents the total number of parallel output lines carrying the output data stream and X represents a whole number counting from 1 representing a count of each successive line forming the output bus carrying the output data stream.

4. A network as defined in claim 2, further comprising an output network for providing an output data stream from a last stage of said multiplexers, the output network being comprised of an output delay network comprising a number of delay stages Q in each parallel stream carrying the output data stream wherein Q=(R−X), where R represents the total number of parallel output lines carrying the output data stream and X represents a whole number counting from 1 representing a count of each successive line forming the output bus carrying the output data stream.

5. A network as defined in claim 4, further comprising a plurality of shuffle buffers for receiving plural input data streams
(a) each data stream but one having a width which is the same as all other input data streams, and
(b) at least one stream of data having different data width than other ones of the input streams of data and in which the data widths of the streams of data have a power of 2 relationship;
the shuffle buffer having a structure for reordering the input streams of data into an interleaved order if not already in interleaved order and providing the interleaved order of data streams at its output.

6. A network as defined in claim 5, further including a permutation network located upstream of the pipelined butterfly network, for receiving streams of data and for rearranging the spatial order of the streams of data if desirable or necessary and locating each stream on a specific spatial boundary, wherein the permutation network is configured to reorder positions of data streams so that byte lanes of respective streams which are a multiple of the narrowest of the data streams are respectively contiguous and are located on a specific spatial boundary.

7. A network as defined in claim 6, wherein at least one of the input streams of data has a wider data width, K being the width of said wider data stream, than other ones of the input streams of data, and the sum of the input streams of data does not exceed the data width of the output bus, and wherein the first log₂K stages of multiplexers of the pipelined butterfly network to which a data stream having the wider data width are applied are frozen so as not to toggle, with their select inputs set so as to render those stages of multiplexers into a straight-through data passage mode.

8. A network as defined in claim 5, in which all of the input data streams are of the same width, and further comprising buffers for at least one of
(a) accumulating input data until complete blocks of data are available within the buffers which are of a size equal to the width of the output bus of the pipelined butterfly network, and
(b) synchronizing the input data streams; and for outputting the at least one of the synchronized input data streams and blocks of data for subsequent processing by the pipelined butterfly network.

9. A network as defined in claim 8, further including a permutation network located upstream of the pipelined butterfly network, for receiving streams of data and for rearranging the spatial order of the streams of data if desirable or necessary and locating each stream on a specific spatial boundary.

10. A network as defined in claim 2, further comprising a plurality of shuffle buffers for receiving plural input data streams
(a) each data stream but one having a width which is the same as all other input data streams, and
(b) at least one stream of data having different data width than other ones of the input streams of data and in which the data widths of the streams of data have a power of 2 relationship;
the shuffle buffer having a structure for reordering the input streams of data into an interleaved order if not already in interleaved order and providing the interleaved order of data streams at its output.

11. A network as defined in claim 10, wherein at least one of the input streams of data has a wider data width, K being the width of said wider data stream, than other ones of the input streams of data, and the sum of the input streams of data does not exceed the data width of the output bus, and wherein the first log₂K stages of multiplexers of the pipelined butterfly network to which a data stream having the wider data width are applied are frozen so as not to toggle, with their select inputs set so as to render those stages of multiplexers into a straight-through data passage mode.

12. A network as defined in claim 11, further comprising an input delay network containing P serial delay stages in which each respective successive parallel input data stream is delayed by said P serial delay stages, where P=(M−1), M being a whole number counting from 1 representing a count of each respective successive input data stream, said input delay network receiving the streams of data and passing each stream to an input of a corresponding multiplexer of a first stage of said multiplexers.

13. A network as defined in claim 11, further comprising an output network for providing an output data stream from a last stage of said multiplexers, the output network being comprised of an output delay network comprising a number of delay stages Q in each parallel stream carrying the output data stream wherein Q=(R−X), where R represents the total number of parallel output lines carrying the output data stream and X represents a whole number counting from 1 representing a count of each successive line forming the output bus carrying the output data stream.

14. A network as defined in claim 13, further including a permutation network located upstream of the pipelined butterfly network, for receiving streams of data and for rearranging the spatial order of the streams of data if desirable or necessary and locating each stream on a specific spatial boundary, wherein the permutation network is configured to reorder positions of data streams so that byte lanes of respective streams which are a multiple of the narrowest of the data streams are contiguous and are located on a specific spatial boundary.

15. A network as defined in claim 1, further comprising a plurality of shuffle buffers for receiving plural input data streams
(a) each data stream but one having a width which is the same as all other input data streams, and
(b) at least one stream of data having different data width than other ones of the input streams of data and in which the data widths of the streams of data have a power of 2 relationship;
the shuffle buffer having a structure for reordering the input streams of data into an interleaved order if not already in interleaved order and providing the interleaved order of data streams at its output.

16. A network as defined in claim 15, further including a permutation network located upstream of the pipelined butterfly network, for receiving streams of data and for rearranging the spatial order of the streams of data if desirable or necessary and locating each stream on a specific spatial boundary, wherein the permutation network is configured to reorder positions of data streams so that byte lanes of respective streams which are a multiple of a narrowest of the data streams are contiguous and are located on a specific spatial boundary.

17. A multi-data-stream merge network comprising:
(a) a plurality of shuffle buffers for receiving plural input data streams
(i) each data stream but one having a width which is the same as all other input data streams, and
(ii) at least one stream of data having different data width than other ones of the input streams of data and in which the data widths of the streams of data have a power of 2 relationship;
the shuffle buffer having a structure for reordering the input streams of data into an interleaved order if not already in interleaved order and providing the interleaved order of data streams at its output.
(b) a permutation network for receiving the interleaved order of data streams and rearranging the spatial order of the data streams if desirable or necessary and locating each stream on a specific spatial boundary, and
(c) a pipelined butterfly network for receiving the data streams from the permutation network and concatenating data from the received data streams into constant width interleaved words having width which is wider than any of the input streams of data, and merging the constant width words onto an output bus in a time-division-multiplexed manner.

18. A merging network for multiple data streams comprising a pipelined butterfly network, the pipelined butterfly network comprising:
(a) an input network for receiving a plurality of data streams of mutually constant widths, having logically related data streams carried on contiguous signal lines,
(b) a butterfly network for rearranging the received data streams into a time-multiplexed constant-width output data stream, the output data stream having a width equal to or greater than the sum of the widths of the input data streams, and
(c) an output network for providing the output data stream interleaved to an output bus.

19. A pipelined butterfly network as defined in claim 18, wherein the input network is comprised of an input delay network having a number P of equal delay stages, where P=(M−1), M being a whole number counting from 1 representing a count of each successive input data stream.

20. A pipelined butterfly network as defined in claim 18, wherein the output network is comprised of an output delay network having similar number of equal delay stages as the input delay network, each delay stage being equal in delay to a delay stage of the input network, the number of delay stages Q in each parallel line carrying the output data stream being Q=(R−X), where R represents the total number of parallel output lines carrying the output data stream and X represents a whole number counting from 1 representing a count of each successive output data stream.

21. A pipelined butterfly network as defined in claim 20, wherein the butterfly network is non-blocking and is comprised of a plurality of stages of multiplexers and delay elements mutually interconnected and selected so as to provide to each parallel line containing said delay stages carrying the output data stream, an ordered and sequential stream of bytes from each successive word of all the input data streams, the sequence of bytes on successive ones of the parallel lines having successive bytes of a data word each delayed by a delay interval of one delay stage.

22. A pipelined butterfly network as defined in claim 21 further including a plurality of input buffers each for receiving a corresponding ordered and sequential stream of bytes, and for providing said corresponding stream of bytes to inputs of the butterfly network in accordance with a predetermined control signal and with a delay of one of said delay stages, and a control circuit for applying control signals to said input buffers and to said multiplexers.

23. A pipelined butterfly network a defined in claim 22 including a clock input to each of the multiplexers, buffers and delay stages for receiving a clock signal for synchronization thereof.

24. A pipelined butterfly network as defined in claim 21 comprising N×log₂N multiplexers and N×(log₂N+1) delay elements, wherein N represents a total number of bytes in a data word at the output of the butterfly network.

25. A pipelined butterfly network as defined in claim 21 in which the received data streams are comprised of one of (a) all of the same width, or (b) different widths wherein the different widths are related to each other by the power of 2; the sum of the widths of the data streams not exceeding the width of the output bus.

26. A pipelined butterfly network a defined in claim 22 including means for providing control signals, comprised of a regular repeating pattern.

27. A method of merging multiple input data streams into an output data stream having a word size that is equal to or larger than the sum of all of the input data streams, wherein the word size of the output data stream is a multiple of the smallest common factor of the word sizes of the input data streams, comprising:
(a) delaying each successive input data stream by a delay clock unit equal to (M−1), M being a whole number representing a count of each successive input data stream counting from 1,
(b) switching each successive byte of each delayed data stream to a corresponding successive internal output line and wherein each corresponding byte of all of the input data streams is in sequence on a corresponding internal data line, and
(c) delaying data streams on each of the internal data lines by respective delay clock units so as to cause all of the sequential bytes of an input data word to appear at the same time in parallel on respective output lines of an output bus, and all of the corresponding bytes of all data words to appear respectively at the same time in parallel, in sequence, and intereleaved, on the output bus.

28. A method as defined in claim 27 in which step (c) is comprised of delaying the data on each internal data line by a number of delay units equal to Q, wherein Q=(R−X), where R represents the total number of parallel output lines carrying the output data stream, and X represents a whole number counting from 1 representing a count of successive output data lines carrying the output data stream.

29. A method of merging multiple input data streams into an output data stream having a word size that is equal to or larger than the sum of all of the input data streams, wherein the word size of the output data stream is a multiple of the smallest common factor of the word sizes of the input data streams, comprising:
(a) receiving a plurality of said input data streams having logically related data widths in an input network,
(b) rearranging the received data streams into a time-multiplexed constant-width output data stream, the output data stream having a width equal to or greater than the sum of the widths of the input data streams, and
(c) providing the output data stream interleaved to an output bus by means of an output network.

30. A method of merging multiple data streams into an interleaved time-division-multiplexed output signal comprising:
(a) receiving plural input streams of data, wherein one of (i) each stream of data has a data width which is the same as all other input streams of data, or
(ii) at least one stream of data has different data width than other ones of the input streams of data and in which the data widths have a power of 2 relationship,
(b) reordering the input streams of data into a interleaved order if not already in interleaved order and providing the interleaved order of data streams at its output,
(c) rearranging the interleaved spatial order of the data streams if desirable or necessary and locating each stream on a specific spatial boundary, and
(d) concatenating data from the interleaved spatially located data streams into constant width interleaved words having width which is wider than any of the input streams of data, and merging the constant width words onto an output bus in a time-division-multiplexed manner.

31. A method of merging multiple data streams into an interleaved time-division-multiplexed output signal comprising receiving streams of data which are in interleaved order and which are located at specific spatial boundaries, concatenating data from the received streams of data into constant width interleaved words having a width which is equal to or is wider than any of the received streams of data, and merging the constant width words onto an output bus in a time-division multiplexed form so as to produce a constant-width interleaved output data stream.

32. A method as defined in claim 31 comprising imposing different fixed numbers of clock cycle delays on various input streams, switching and sequencing the delayed input streams in successive stages to merge and extend data in the delayed input streams, and imposing different fixed numbers of clock cycle delays on the merged and extended data so as to align the merged and extended data into interleaved words of the constant width output data stream.

33. A network for splitting a time-division multiplexed constant width interleaved data stream into multiple data streams including a pipelined butterfly network for receiving said interleaved data stream, means for deconcatenating data from the received data stream into separate data streams and serializing each of the separate data streams into serial data streams of words having widths which are narrower than the width of the interleaved data stream, the widths of the serial data streams having a power of 2 relationship to each other.

34. A network as defined in claim 33, including a shuffle buffer for receiving the plural streams of data and for reordering the plural data streams in accordance with output data bus requirements.

35. A splitting network for converting an interleaved time-division multiplexed constant width data stream into multiple data streams comprising:
(a) an input network for receiving the interleaved time-division-multiplexed constant width parallel data stream,
(b) a butterfly network for rearranging the received data stream into a plurality of data streams having logically related widths and carried on contiguous signal lines, the sum of the widths of the plurality of data streams being equal to or smaller than the width of the interleaved data stream, and
(c) an output network for providing the plurality of data streams on plural output buses individually timed to output bus requirements.

36. A method of converting an interleaved time-division multiplexed constant width data stream into multiple data streams comprising:
(a) receiving the interleaved time-division-multiplexed constant width parallel data stream,
(b) rearranging the received data stream into a plurality of data streams having logically related widths and carried on contiguous signal lines, the sum of the widths of the plurality of data streams being equal to or smaller than the width of the interleaved data stream, and
(c) providing the plurality of data streams on plural output buses individually timed to output bus requirements.
